(19) United States
(12) Patent Application Publication
(10) Pub. No.: US 2015/0235153 A1
(43) Pub. Date: Aug. 20, 2015

(54) SYSTEM AND METHOD FOR RANKING NATURAL HAZARD MODELS

(71) Applicant: Corelogic Solutions, LLC, Irvine, CA (US)

(72) Inventors: Wei DU, Springfield, VA (US); Rouzbeh TABADDOR, Irvine, CA (US)

(21) Appl. No.: 14/619,288

(22) Filed: Feb. 11, 2015

Related U.S. Application Data
(60) Provisional application No. 61/940,715, filed on Feb. 17, 2014.

(51) Int. Cl. G06Q 10/06; G06Q 50/16

(52) U.S. Cl. CPC G06Q 10/0635; G06Q 50/163

(57) ABSTRACT

A computer system programmatically determines a ranking of the plurality of natural hazard models (NHMs) based at least in part on calculation of one or more indicators of accuracy for each of the NHMs. The indicators of accuracy for each of the NHMs are based at least in part on the NHM's prediction of natural hazard events for the one or more properties and the reference event for the one or more properties. The computer system may be provided for assessing risks with assets, such as personal or real properties.

### CROSS-REFERENCE TO RELATED APPLICATIONS

The present application claims the benefit of U.S. Provisional Application No. 61/940,715, titled “SYSTEM AND METHOD FOR RANKING NATURAL HAZARD MODELS,” filed Feb. 17, 2014, the disclosure of which is hereby incorporated by reference in its entirety.

### TECHNICAL FIELD

Various embodiments described herein relate to data processing apparatus, systems and methods for testing and ranking of multiple natural hazard models.

### BACKGROUND

The need to accurately identify natural hazard risks for real and personal properties has grown steadily in the last several decades, with the observance of ever increasing property loss due to earthquakes, hurricanes, wildfires, floods and various severe weather events, all of which being hazard risks. The first decade of the twenty-first century has witnessed ever greater concern over the locations of properties in relation to natural hazard regions and/or paths of frequency. Historically, risk to properties has been, and continues to be, evaluated separately for each risk category. For example, a single residential property along the coast of California may be evaluated for earthquake risk. Such an earthquake risk may be evaluated by using one or more natural hazard models.

The risks provided by conventional natural hazard models vary in accuracy. Currently, no standardized means by which to compare the accuracy of one natural hazard model to that of another are known to exist. Moreover, conventional means for modeling and comparing natural hazard risks have failed to take advantage of the increased capabilities of computer systems.

### SUMMARY

Different natural hazard models use different methodologies, model assumptions, scientific datasets and uncertainty treatments, therefore, the results derived from those models can be significantly different. The present disclosure addresses these and other issues by providing systems, methods and non-transitory computer storage for determining the accuracy of natural hazard models that predict natural hazard events or assessments. Using and cascading multiple models across different scientific and engineering fields, different companies, different governmental agencies, and scientists with different experiences can increase the reliability of hazard risk assessment and reduce uncertainties associated with hazard risk assessment.

In some embodiments, the system of the present disclosure determines the accuracy of natural hazard models (NHMs) that predict natural hazard or catastrophic events or assessments for one or more properties by calculating one or more indicators of accuracy for each of the NHMs, then determines a ranking of the NHMs based at least in part on the indicators of accuracy. The system comprises physical data storage for storing data for a reference event (e.g., an earthquake, a flood, a fire, or a storm) for the properties and a plurality of predicted natural hazard events or assessments for the properties. Each of the predicted natural hazard events or assessments is generated by a respective one of a plurality of NHMs without using of all of the available data for the reference event for the properties, wherein different predicted natural hazard events correspond to different NHMs.

The system may be provided by a business entity or “rankings provider” that provides various services to its customers for assessing risks with assets, such as real estate properties.

### BRIEF DESCRIPTION OF THE DRAWINGS

The accompanying drawings are presented to aid in the description of embodiments of the disclosure and are provided solely for illustration of the embodiments and not limitations thereof.

FIG. 1 is a block diagram that schematically illustrates an example of a system to rank natural hazard models.

FIG. 2 is a flowchart illustrating a method of ranking natural hazard models in accordance with an embodiment.

FIG. 3 is a block diagram that schematically illustrates an example of one or more accuracy indicators that may be created in accordance with an embodiment.

FIG. 4 is a block diagram that schematically illustrates an example of one or more ranking criteria that may be analyzed in accordance with an embodiment.

FIG. 5 is a flowchart illustrating a method of identifying a natural hazard risk using a ranking of natural hazard models.

FIGS. 6A-C are examples of user interfaces that may be provided to customers in accordance with an embodiment.

### DETAILED DESCRIPTION OF EMBODIMENTS

The disclosure provided in the following pages describes examples of some embodiments. The designs, figures, and descriptions are non-limiting examples of some embodiments. Other embodiments of the system may or may not include the features disclosed herein. Moreover, some of the disclosed advantages and benefits may apply to only some embodiments of the disclosure, and should not be used to limit the scopes of the claims.

Exemplary implementations of the disclosed systems and methods will be described in the context of providing ranking of natural hazard models for real estate properties. These implementations are for purposes of illustration and are not limitations on the scopes of the claims. For example, implementations of the disclosed systems and methods can be used to provide ranking of natural hazard models for commercial property developments such as office complexes, industrial or warehouse complexes, retail and shopping centers, apartment rental complexes, vehicles, equipment, or any other tangible or intangible asset for which loan financing may be obtained.

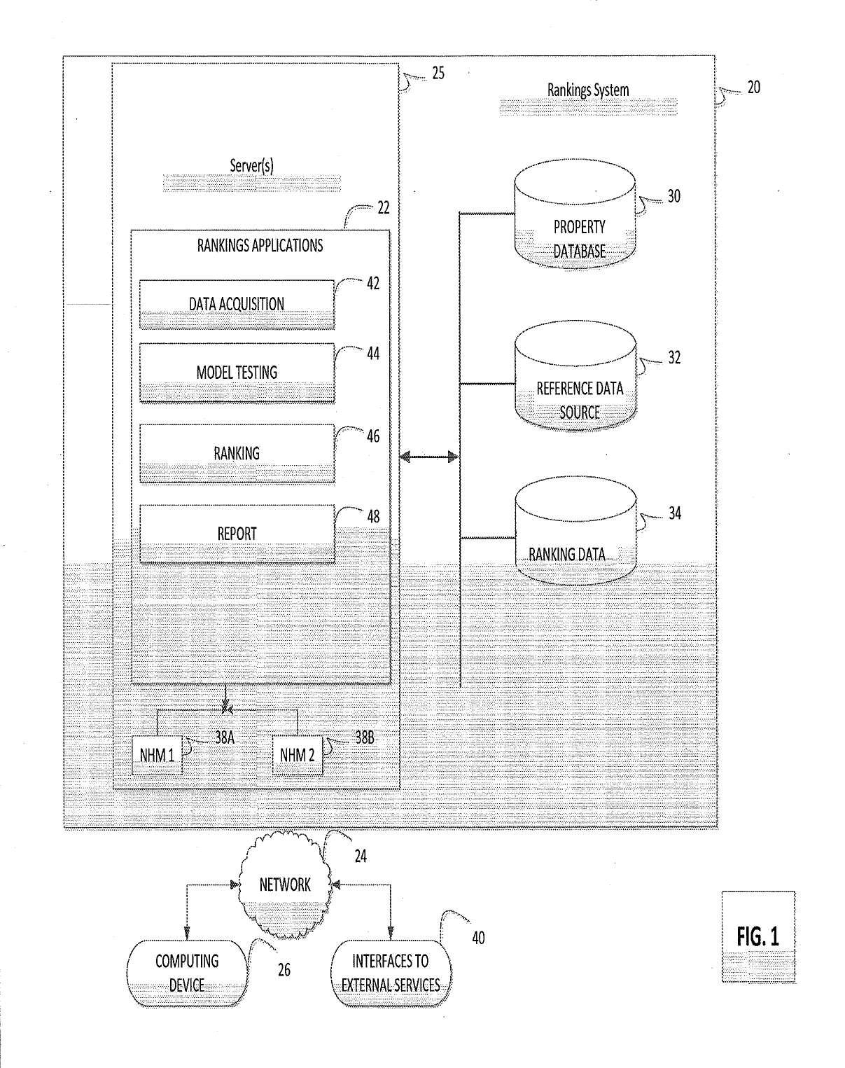

FIG. 1 illustrates a ranking system 20 according to an embodiment. The system may be provided by a business entity or “rankings provider” that provides various services to its customers for assessing risks with assets, such as real estate properties. As illustrated in FIG. 1, the system includes a set of rankings applications 22 that are accessible over a network 24 (such as the Internet, a wireless network, a private network, etc.) via a computing device 26 (desktop computers, mobile phones, servers, etc.). Typical customers of the ranking system 20 may include mortgage lenders, other types of lenders, mortgage and default servicers, real estate investors, real estate brokers, real estate appraisers, and so on.

As illustrated, rankings applications 22 use a set of data repositories 30-34 to perform various types of analytics tasks, including tasks associated with ranking natural hazard models. In the illustrated embodiment, these data repositories 30-34 include a database of property data, property database 30, a reference data source 32, and a database of ranking data 34. Although depicted as separate databases, some or all of these data collections may be merged into a single database or distributed across multiple distinct databases. For example, the property database 30 may be a single database stored on a single hard drive or server, or be distributed across multiple databases in a network, such as a cloud network. Likewise, other databases such as the reference data source 32 or the database for ranking data 34 may be single databases or distributed databases in a network, such as a cloud network. Furthermore, additional databases containing other types of information may be maintained and used by the rankings applications 22. As shown in FIG. 1, each rankings application 22 may run on one or more physical servers 25 or other computing devices.

In an embodiment, the property database 30 contains property data obtained from one or more of the entities that include property data associated with real estate properties. This data may include the type of property (single family home, condo, etc.), the sale price, and some characteristics that describe the property (bedrooms, bathrooms, square feet, etc.). These types of data sources may be found online, for example, by visiting free-of-charge websites or fee-for-access websites. For example, multiple listing services (MLS) contain data intended for real estate agents, and can be contacted and queried through a network such as the Internet. Such data may then be downloaded for use according to various embodiments of the disclosure. Other examples include retrieving data from databases/websites such as Redfin, Zillow, etc. that allow users to directly post about available properties. Furthermore, the property database 30 may contain aggregated data collected from public recorder offices in various counties throughout the United States. This database 30 may include property ownership information and sales transaction histories with buyer and seller names, obtained from recorded land records (grant deeds, trust deeds, mortgages, other liens, etc.). In an embodiment, the rankings provider maintains this database 30 by purchasing or otherwise obtaining public record documents from most or all of the counties in the United States (from the respective public recorders offices), and by converting those documents (or data obtained from such documents) to a standard format. Such a database is maintained by CoreLogic, Inc. The property database 30 may be updated periodically, for example, on a daily or near-daily basis, such that it closely reflects the current ownership statuses of properties throughout the United States. The property database 30 may be also updated continually. In an exemplary implementation, the database 30 may cover at least 97% of the sales transactions from over 2,535 counties in the United States.

In an embodiment, the reference data source 32 is a continually updated source of real estate natural hazards data. It need not necessarily be one source. The reference data source 32 may be representative of many sources of natural hazard data, such as hydrologic data services, meteorological data services, weather data services, GIS and mapping services, live hazard event warning and tracking services, or the like. The reference data source 32 is continually updated with data corresponding to the occurrence of natural hazards including the damage, frequency, intensity, or loss associated with the occurrence of the natural hazard. In an embodiment, the reference data from the reference data source 32 is an actual occurrence of a natural hazard. In other embodiments, the reference data from the reference data source 32 may not be an actual occurrence of a natural hazard. Instead, the reference data may include statistic samples of past occurrences of natural hazards, for example.

The ranking system 20 may also include online data resources (not shown) that provide available natural hazard data for real estate properties. Examples of online data resources containing natural hazard data may include servers owned, operated, or affiliated with local governments, National Weather Service (“NWS”), Weather Services International (“WSI”), or any other server or service containing natural hazard data.

As further shown in FIG. 1, the ranking system 20 may also include one or more interfaces 40 to other (externally hosted) services and databases. For example, the system may include APIs or other interfaces for retrieving data from WSI, NWS, news agencies, particular real estate companies, government agencies, and other types of entities.

As further shown in FIG. 1, the rankings applications 22 may include a “data acquisition” application or application component 42 (hereinafter “application 42”). As explained below, this application 42 uses some or all of the data sources described above to acquire natural hazard and property data from one or more entities and store the acquired data in the property database 30 and/or the reference data source 32.

The rankings applications 22 further include a “model testing” application or application component 44 (hereinafter “application 44”). As explained below, this application or component 44 can communicate with application 42, to test natural hazard models (“NHM”). In an embodiment, application 44 can communicate with MHM1 38A or MHM2 38B, e.g., via application 42, to determine a natural hazard risk for a particular property or group of properties and test the received results.

In an embodiment, the rankings applications 22 may further include a “ranking” application or application component 46 (hereinafter “application 46”). As explained below, this application or component 46 may communicate with application 44 to rank the NHMs based on the results of the testing, for example.

In an embodiment, the rankings applications 22 may further include a “report” application or application component 48 (hereinafter “application 48”). As explained below, this application or component 48 generates reports based on the rankings data.

### Example Natural Hazards Model Ranking Process

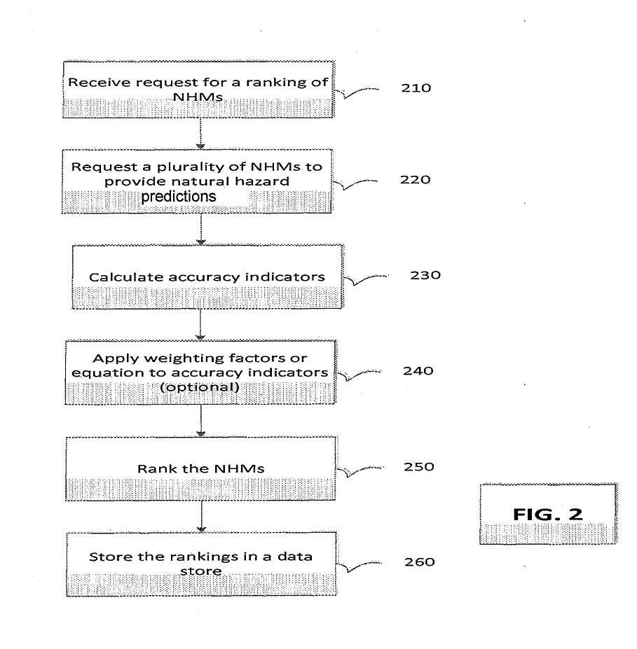

FIG. 2 illustrates one embodiment of an automated process that may be used by the rankings application 22 to rank natural hazard models. In an embodiment as depicted by block 210 of FIG. 2, the rankings application 22 initially receives a data request for a ranking of NHMs. The request may be submitted by the computing device 26 via the network 24. The user of computing device 26 may submit the request via a web page, a web services call, a mobile application, or any other appropriate interface. The submission may either be manual (e.g., a user submits a web form) or automated (e.g., a customer's computer system generates a web service or other type of call). In some embodiments, the request for a ranking of NHMs may be an automated or periodic request generated by rankings application 22. For example, application 44 may generate a request every month to rank NHMs in Akron, Ohio for a variety of different hazard types or risk types (discussed further below).

In an embodiment as shown in block 220 of FIG. 2, the rankings application 22 then makes natural hazard risk requests to each natural hazard risk model to be tested. In an embodiment, the natural hazard risk request may be based on a received user request. In this embodiment, the hazard type, geographic area, timeframe, risk type, or any other factor may be based on the user request. For example, if the user has requested a ranking of NHMs for predicting damage and loss from earthquakes in Los Angeles, Calif., the application 44 may identify all available natural hazard data associated with a particular earthquake event in Los Angeles and provide a portion of the data to the NHMs to predict the natural hazard risks associated with the particular earthquake. For instance, the application 44 may identify one or more earthquakes in Los Angeles and provide the date and intensity of the earthquakes to the NHMs. The NHMs may then predict damage/loss from those earthquakes which the application 44 then can compare to the actual loss/damage data stored in reference data source 32. The received natural hazard risks from the NHMs may also be stored in the reference data source 32. The database which stores the natural hazard model risks and the actual natural hazard occurrence data or other reference data is continuously updated and becomes increasingly useful for deriving measures of the accuracy of each natural hazard model.

In an embodiment, the risk data provided by each natural hazard model is done without reference to all of the natural hazard data associated with the occurrence being evaluated. The occurrence to be evaluated may be a historical natural hazard event or a current natural hazard event for which associated natural hazard data is being determined in real-time. Reference natural hazard data is gathered using this method for both the purpose of testing natural hazard models and also to provide that reference natural hazard data to natural hazard models. Most natural hazard model databases are only updated monthly or quarterly. Therefore, each natural hazard model in some cases will likely provide a natural hazard risk for any current natural hazard subject occurrence without reference to the most recent natural hazard occurrence data because it has not yet been provided. Even if a particular natural hazard model is updated on a weekly or even a daily basis, embodiments of the present embodiments provide accuracy testing of the natural hazard models prior to the natural hazard models receiving data of the most recent natural hazard occurrence for updates to natural hazard models. This would enable a more effective gauge for the accuracy of each natural hazard model being tested. In some embodiments, as discussed above, each natural hazard model may be provided a portion of the collected natural hazard data associated with a natural hazard occurrence in order to have the natural hazard models predict other aspects of the natural hazard data. Then the accuracy of the natural hazard models may be determined by comparison with the portions of the collected natural hazard data that was not provided to the natural hazard models. Once each request is made and each natural hazard model responds with its risk evaluation, this data is received and stored in the same database as the reference data. Alternatively, this data may be stored in a separate database from that of the reference data or in individual databases for each natural hazard model being tested.

In an embodiment as shown in block 230 of FIG. 2, the application 44 then calculates accuracy indicators for the risk evaluations provided by the natural hazard models. The natural hazard models may provide risk evaluations based on probability of a particular natural hazard, intensity of a particular natural hazard, estimated loss from a particular natural hazard, damage caused by a particular natural hazard, or the like. The results from application of the NHMs are then compared to the reference values collected in the reference data source 32. Each of the indicators of accuracy are calculated for each natural hazards model. This is done using the aggregate reference values and risk evaluations for each natural hazard occurrence over a set period of time. Alternatively, these indicators of accuracy may be calculated for only a smaller subset of all of the natural hazard data available. The accuracy indicators can correspond to a percentage or an average percentage of a plurality of risk evaluations that may be used to show, in general, the accuracy of each of the tested natural hazard models.

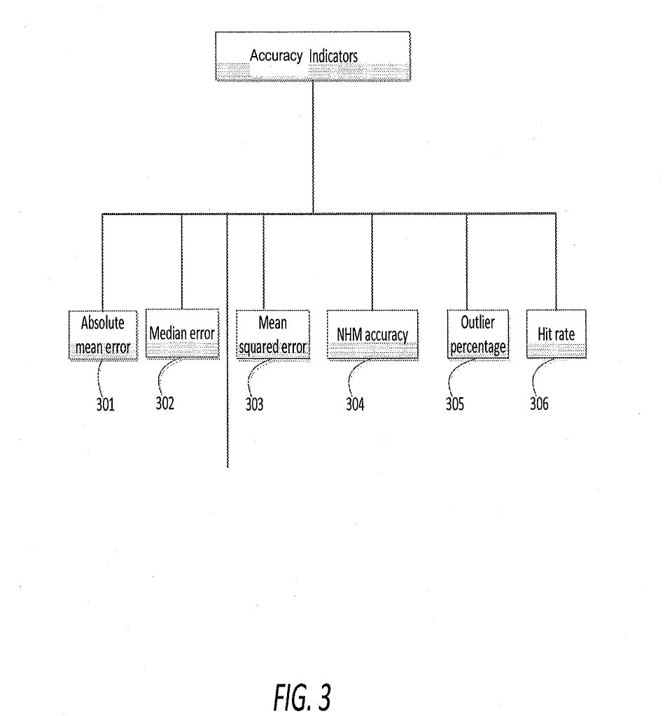

In some embodiments, the various indicators of accuracy may be calculated as percentages, decimals or fractions, as illustrated in FIG. 3. These indicators may include, for example, absolute mean error 301, median error 302 to the reference value (usually the reference natural hazard data), mean squared error 303, natural hazard model (NHM) accuracy 304 (defined as the percentage of risk evaluations within a predetermined percentage of the reference value, such as 10% of the reference value), outlier percentage 305 (defined as risk evaluations that are beyond a predetermined percentage of the reference value, such as 25% more or less than the reference value), and hit rate 306 (defined as percentage of properties for which the NHM was able to return an evaluation).

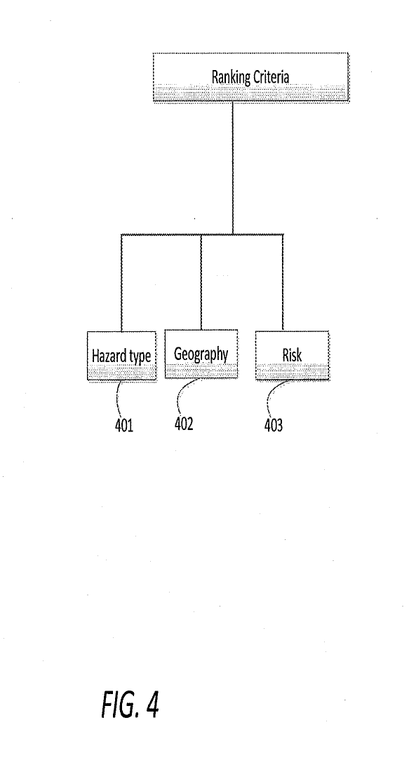

These indicators of accuracy may be calculated periodically or on command by a user. Over time, these calculations may be made to provide an increasingly more accurate picture of a particular natural hazard model's accuracy overall and in particular ranking criteria. For example, as illustrated in FIG. 4, a natural hazard model's accuracy may be ranked by hazard type 401, geographic area 402, or risk 403 (e.g., damage, probability, loss, intensity, etc.). Additionally, these indicators of accuracy may be calculated for particular time frames, for example, if some improvements have been made recently to a particular natural hazard model, then the indicators of accuracy and subsequent rankings dependent upon them may be calculated for the time since the improvements were made.

Subsequently, in an embodiment as shown in block 240 of FIG. 2, the application 44 then optionally applies weighting factors or equation to accuracy indicators. For example, the weighting factors can be as follows:

hit rate is multiplied by 0.05 or 5%

median error is multiplied by 0.1 or 10%

absolute mean error is multiplied by 0.1 or 10%

mean error squared is multiplied by 0.1 or 10%

Natural hazard model accuracy is multiplied by 0.35 or 35%

outlier percentage is multiplied by 0.30 or 30%.

Different weights or factors may be applied as desired. Each of the above accuracy indicator calculations may result in a decimal number that is representative of a percentage value. Depending on the indicator of accuracy, a large percentage may indicate accuracy or may indicate inaccuracy. A large percentage, for example in hit rate percentage, may indicate accuracy. In one embodiment, the highest hit rate percentage is ranked number one in a particular geographic area, hazard type, or risk. In other indicators of accuracy, for example absolute mean error, a lower percentage indicates more accuracy, stating that the average percentage of value that this particular natural hazard model “misses” the target. For this indicator and in this embodiment, the lowest percentage is ranked highest. In each of the categories, each natural hazard model is ordinally ranked as compared with every other natural hazard model. In this embodiment, these rankings are then multiplied, for each of the natural hazard models in each geographic area, hazard type, or risk, by the associated weighting factor. Each of these multiplied values are added together and multiplied by a scaling factor, such as ten, which results in an “accuracy score.” The lowest accuracy score in a particular geographic area, hazard type or risk is the most accurate natural hazard model.

In an embodiment as shown in block 250, application 46 ranks the NHMs as described above. For example, each NHM may be ranked in each indicator of accuracy and in each category-geographic area, hazard type, or risk—by ordinal numbers, then the ordinal number for each NHM's ranking is multiplied by its corresponding weighting factor, and the products of these multiplications are summed. The corresponding sum of the products is then used to rank the natural hazard models in the embodiments described. In the embodiment that uses ordinal rankings multiplied by weighting factors, the lowest summed number is the most accurate natural hazard model, and the next lowest summed number is the next most accurate.

In an alternative embodiment that uses a weighting equation, an overall accuracy indicating score can be created using an additional formula, rather than ranking each natural hazard model compared to another. In this embodiment, each of the accuracy indicators is calculated in much the same way, but they are weighted using a formula or equation. In the alternative embodiment, the highest calculated number is the most accurate natural hazard model, and the next highest calculated number is the next most accurate. The natural hazard models are then ranked according to which has the highest accuracy score.

In some embodiments, the rankings may be calculated based on price ranges or taking into account the cost to request each natural hazard model evaluation, such that a ranking may be generated for the natural hazard model of the best accuracy for the cost or the natural hazard model that is best in a particular price range or geographic area. Additionally, secondary rankings may be made as to accuracy excluding data referenced by the primary (or most accurate) natural hazard model overall. Alternatively, the secondary rankings may be further subdivided to exclude only the data referenced by the primary (or most accurate) natural hazard model in a particular geographic area, hazard type or risk.

The ranking system 20 can help users reduce uncertainties associated with their hazard data estimation by using the optimal hazard model recommended by the rankings applications 22. In some embodiments, business rules for cascading hazard risk models may be used. The business rules may include, but are not limited to, those listed below:

Scientific Soundness. Scientific soundness can be defined by many factors, for example, number of scientific data sets used for building the model, number of observation stations used for model calibration, sizes (e.g., years) of historical records used, sizes of the derived hazard event sets, scientific and model assumptions, actuarial assessments conducted, number of years of the hazard model used in the commercial market, number of transactions executed through the historical model use, other related studies, and so on.

Client Reviews and Rating. Clients' feedback and rating are important information for assessing whether hazard models are useful for supporting their businesses. The deeper the hazard model is adopted into clients' routine business process, the more sufficient the hazard model would be. The ranking system 20 has a functionality that allows users to enter their review on the hazard models and their experience.

Flexibility and Ease of Use. Hazard risk score and rating should be easy and flexible to be used. However, certain catastrophe hazard model can be very complex, thus requires comprehensive input data and settings. Therefore, flexibility and usability are important for clients. Flexibility and ease of use can be defined by many factors, for example, allowing users to select hazard perils, methods (such as risk score vs. catastrophe model, etc.) and other preferences; adopting multiple common input formats (such as Excel, Access, Dbase, Text, Oracle, SQL Server, DB2, and others); allowing users to easily map property occupancies and structure types; allowing users to easily enter business line coverage (such as buildings, contents, business interruptions, etc.) and map the client's data field to the fields implemented by the ranking system 20; allowing users to easily define financial conditions (such as deductibles, limits, shares, etc.) at all levels, e.g., coverage level, location and/or site level, policy level, portfolio level, etc.; allowing users to easily model hazard mitigation measures, such as building codes, elevated structures, flood walls and levees, and others; and so on.

General Matching Rates with Claim Data. Hazard loss and/or claim data present actual hazard loss happened in the real world. The higher percentage the hazard model results match with hazard loss and/or claim data, the more reliable the hazard model is. The high matching rate with hazard loss and/or claim data will increase clients' confidence on the hazard model and promote the hazard model use.

Geocoding Accuracy. Commonly, hazard risk assessment should focus on the structures but not on the land surrounding the structures. Geocoding accuracy can be classified as: rooftop and/or building footprint, property parcel, street segment extrapolation, zip code level, etc. The higher geocoding coding accuracy level is used, the more accurate the hazard risk assessment is.

Geographical Preference. Natural hazards are unevenly distributed on the earth surface. Some hazard models may have a consistent performance to predict hazard risk through the entire country, but some others may produce more accurate results in specific geographic regions (such as riverine flood vs. coastal storm surges, etc.). Those geographical behaviors of the hazard models can be important for clients to use hazard models in a rational way.

Resolution of Elevation Dataset. Elevation datasets are commonly used in various types of hazard models, for example, in flood related hazard model. The resolution of elevation dataset used in the hazard model has a direct impact on the accuracy of the hazard model outcomes. For example, the 10 m resolution based flood models would produce more accurate results than those from the 90 m resolution based flood models.

Geospatial Output Capability. Geospatial output of hazard models allows clients to visualize the hazard risk in large geography. Hazard risk score and rating map and hazard loss distribution in geography are tools for helping clients to understand the portfolio risk that they are facing.

Consulting Service Availability. Some clients require the hazard modeling service providers to conduct full hazard analyses for them and send analytical results back to them with well formatted reports. Consulting service availability would add additional points for the hazard model use.

Model Transaction Cost. The cost of hazard risk assessment may be sensitive to many clients. Therefore, the price of the use for each individual hazard model should be an important factor for evaluating criteria on the hazard model selection.

Governmental Standard Compliance. In some countries, for example, the United States, the government may involve with insurance business. For example, in the United States, FEMA provides the national flood insurance coverage for the entire country. FEMA defines high flood risk area as the Special Flood Hazard Area (SFHA). Some flood risk assessment tools are consistent with the governmental risk classifications, while some others don't. The ranking system's 20 Flood Risk Score product, for example, is a FEMA Flood zone compliance application.

Model Performance and Reliability. The hazard model's performance and reliability may have impact on clients' applications and usage. It is common that clients' portfolios contain thousands or millions of locations. If a hazard model has a poor performance, it could be a bottleneck for the clients' analyses.

Overall Model Rating. The overall rating of hazard models can be derived from the individual rating listed above. The overall model rating represents the recommendation of the ranking system 20 and may be a trigger for automatically switching the optimal hazard model used during a hazard risk and loss analysis.

In an embodiment as shown in block 260, the application 48 stores the rankings in a data store. The rankings may also be used to generate a report based on the analysis described above. The report may then be provided to the customer or user of the NHMs. The results of the preceding steps may be incorporated into one or more electronic reports in any format desired. In some cases, the auto-generated reports may be manually reviewed and modified by human personnel before they are made available to the customer.

### Example Application of a Natural Hazards Model Ranking Process

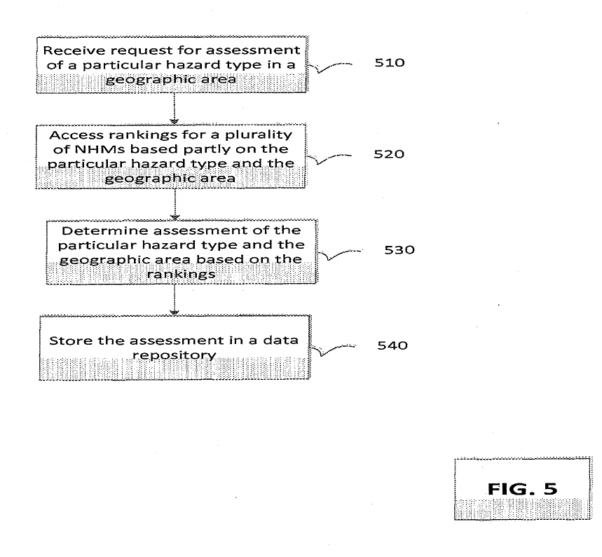

FIG. 5 illustrates an embodiment of an automated process that may be used to identify natural hazard risks based on a ranking of NHMs. As depicted by block 510 of FIG. 5, the application initially receives a request for assessment of a particular hazard type in a geographic area. The request may be received from computing device 26 via the network 24. The user of computing device 26 may submit the request via a web page, a web services call, a mobile application, or any other appropriate interface. The submission may either be manual (e.g., a user submits a web form) or automated (e.g., a customer's computer system generates a web service or other type of call). In an embodiment, the user is from a user interested in providing a loan for a real estate property or insuring a real estate property. The request may be based on an actual property the user is interested in or may be a general request that is not linked to a property.

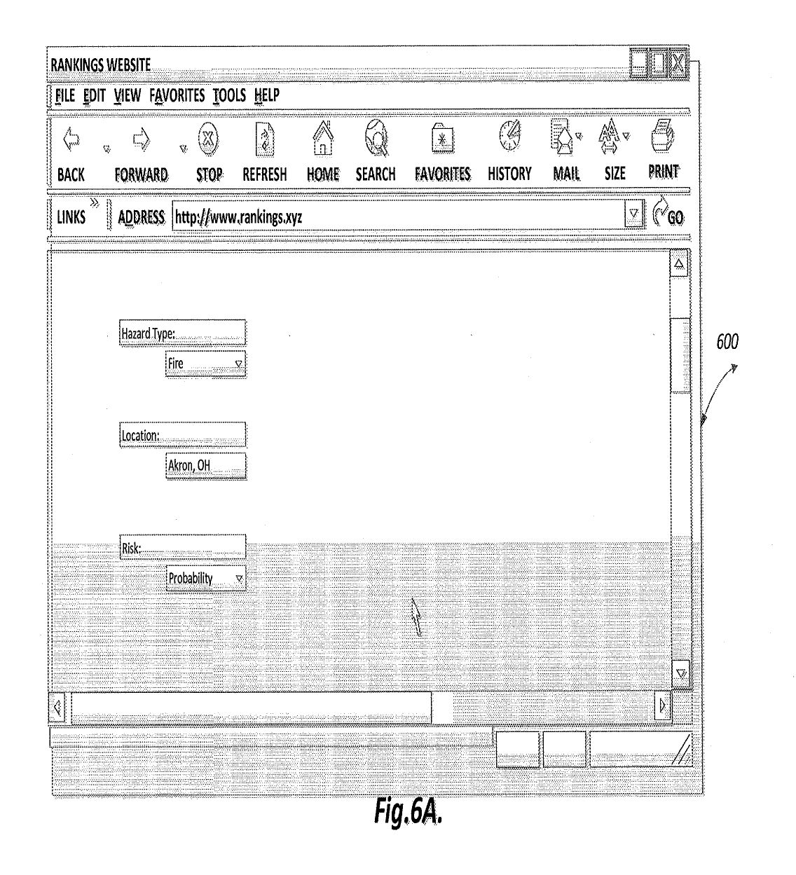

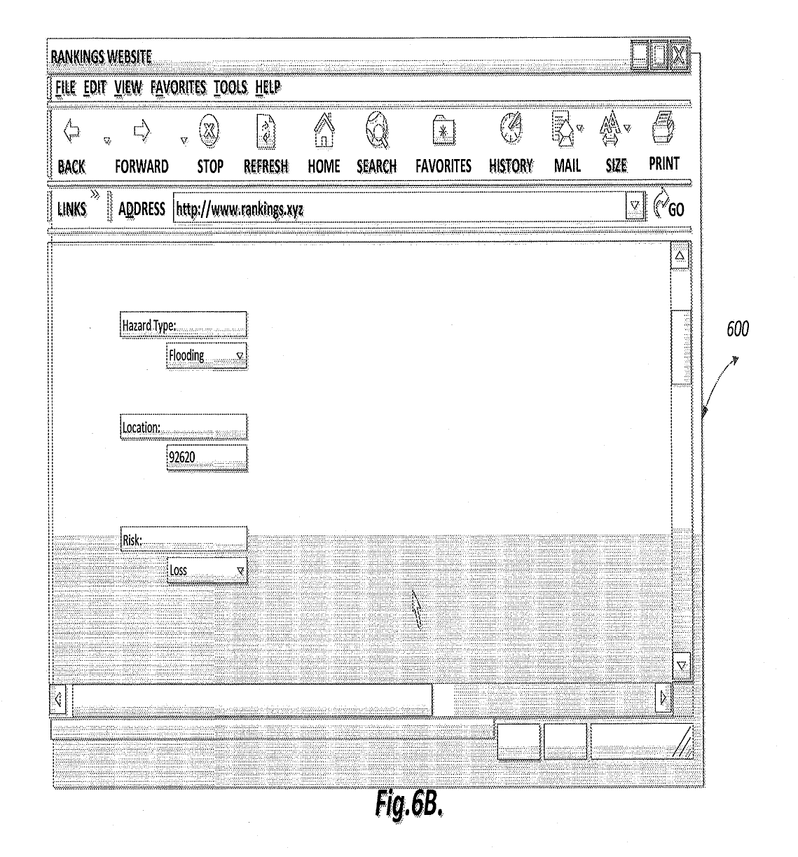

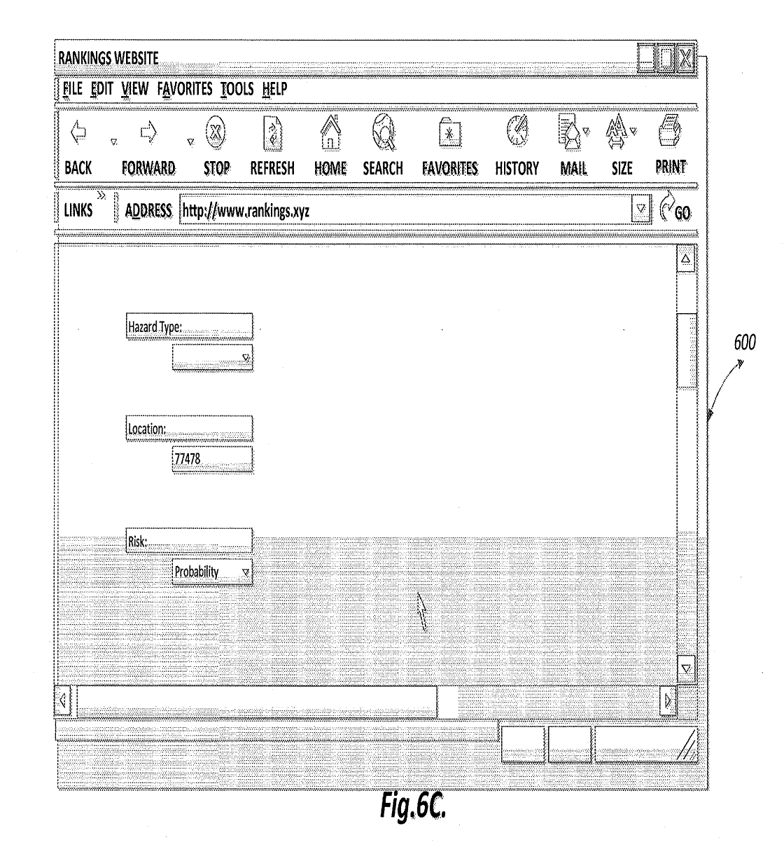

FIGS. 6A-6C, by way of example, illustrate in interface 600 the types of information that can be provided by the potential customer in the request. As illustrated in FIG. 6A, the customer may indicate that he or she is interested in identifying fire hazards in Akron, Ohio. The customer also may indicate that he or she is interested in the probability of the fire hazard. The customer may be insuring a property in Akron, Ohio or may be considering potentially providing a loan in Akron, Ohio FIG. 6B illustrates another example of a request by a customer. In this example, the customer may indicate that he or she is interested in identifying flooding risks in the zip code of 92620. The customer may also indicate they are interested in the loss risk or damage from the flooding risks. FIG. 6C illustrates yet another example of a request by a customer. As illustrated, the customer may indicate that he or she is interested in the probability of all natural hazard risks in the zip code of 77478. A variety of different configurations and requests are possible in various embodiments.

As shown in block 520 of FIG. 5, the application then accesses rankings for a plurality of NHMs based on the customer request. As discussed above NHMs may be ranked based on the specified hazard type, geographic area, and risk.

Subsequently, as shown in block 530 of FIG. 5, the ranking of NHMs are used to assess the natural hazard risk that was requested based on the rankings. A ranked order of NHMs in the requested geographic area, hazard type, and risk may be applied to determine the natural hazard risk.

As shown in block 540 of FIG. 5, the determined natural hazard risk may be stored in a data repository. The determined natural hazard risk may be provided to the requesting customer or incorporated into a report as discussed above.

The various illustrative logical blocks, modules, and processes described herein may be implemented as electronic hardware, computer software, or combinations of both. To illustrate this interchangeability of hardware and software, various illustrative components, blocks, modules, and states have been described above generally in terms of their functionality. However, although some of the various modules are illustrated separately, they may share some or all of the same underlying logic or code. Certain of the logical blocks, modules, and processes described herein may instead be implemented monolithically.

The various illustrative logical blocks, modules, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, microcontroller, state machine, combinations of the same, or the like. A processor may also be implemented as a combination of computing devices, e.g., a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, in a combination of the two, or in firmware. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, hard disk, a removable disk, a CD-ROM, memory capable of storing firmware, or any other form of computer-readable storage medium known in the art. An exemplary computer-readable storage medium can be coupled to a processor such that the processor can read information from, and write information to, the computer-readable storage medium. In the alternative, the computer-readable storage medium may be integral to the processor. The processor and the computer-readable storage medium may reside in an ASIC.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and from the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain embodiments described herein may be implemented in a form that does not provide all of the features and benefits set forth herein, as some features may be used or practiced separately from others.

The methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as the data acquisition module 42, model testing module 44, ranking module 46, and report module 48, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 30-34, relational databases and flat file systems that use magnetic disk storage and/or solid state RAM. Some or all of the components shown in FIG. 1, such as those that are part of the Customer System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the claims to the precise forms disclosed. Many modifications and variations are possible in view of the above teachings. The embodiments were chosen and described in order to explain the principles of the disclosure and their practical applications, to thereby enable others skilled in the art to utilize the disclosure and various embodiments with various modifications as are suited to the particular use contemplated.

What is claimed is:

1. A system comprising:
a computer system comprising:
physical data storage configured to store (1) data for a reference event for one or more properties and (2) a plurality of predicted natural hazard events for the one or more properties, wherein each of the predicted natural hazard events for the one or more properties is generated by a respective one of a plurality of natural hazard models (NHMs) without using all of the available data for the reference event for the one or more properties, wherein different predicted natural hazard events correspond to different NHMs; and
a computer system in communication with the physical data storage, the computer system comprising computer hardware, the computer system programmed to at least to:
calculate one or more indicators of accuracy for each of the NHMs; and
determine a ranking of the plurality of NHMs based at least in part on said one or more indicators of accuracy.

2. The system of claim 1, wherein said one or more indicators of accuracy for each of the NHMs are calculated based at least in part on the NHM's prediction of natural hazard events for the one or more properties and the reference event for the one or more properties.

3. The system of claim 1, wherein the respective one of NHMs generates the prediction of natural hazard events for the one or more properties before being provided with all of the data associated with the reference event for the one or more properties.

4. The system of claim 1, wherein the reference event for the one or more properties comprises at least one of an earthquake, a flood, a fire, or a storm for the one or more properties.

5. The system of claim 1, wherein said one or more indicators of accuracy comprise an error value calculated based at least in part on a predicted loss from the predicted natural hazard events for the one or more properties by an NHM and a loss from the reference event for the one or more properties.

6. The system of claim 5, wherein the error value comprises at least one of an absolute mean error, a median error, or a mean squared error.

7. The system of claim 1, wherein the computer system is programmed to:
determine an accuracy score for each of the NHMs based at least in part on said one or more indicators of accuracy for each of the NHMs; and
determine the ranking of the plurality of NHMs based at least in part on the accuracy scores.

8. The system of claim 7, wherein the computer system is programmed to determine the accuracy score by weighting at least some of said one or more indicators of accuracy.

9. The system of claim 1, wherein the computer system is programmed to determine the ranking of the plurality of NHMs based at least in part on costs to request the prediction of natural hazard events from the plurality of NHMs.

10. The system of claim 1, wherein the computer system is programmed to determine the ranking of the plurality of NHMs in one or more categories for said one or more properties.

11. The system of claim 10, wherein said one or more categories comprise at least one of a hazard type, a risk, or a geographic area.

12. The system of claim 1, wherein the computer system is programmed to determine the ranking of the plurality of NHMs using one or more business rules.

13. A system comprising:
a computer system comprising:
physical data storage configured to store (1) data for a reference event for one or more properties and (2) a plurality of predicted assessments for the one or more properties, each predicted assessment for the one or more properties generated by a natural hazard model (NHM) without using all of the data associated with the reference event for the one or more properties, wherein different predicted assessments correspond to different NHMs; and
a computer system in communication with the physical data storage, the computer system comprising computer hardware, the computer system programmed to:
calculate one or more indicators of accuracy for each NHM, the one or more indicators of accuracy for each NHM based at least in part on the NHM's predicted assessments for the one or more properties and the reference event for the one or more properties, wherein the NHM generates the predicted assessments for the one or more properties before being provided all of the data associated with the reference event for the one or more properties, all of the data associated with the reference event available to but not used by the NHM for the predicted assessments; and
determine a ranking of the plurality of NHMs based at least in part on the one or more indicators of accuracy.

14. The system of claim 13, wherein the reference event for the one or more properties comprises at least one of an earthquake, a flood, a fire, or a storm for the one or more properties.

15. The system of claim 13, wherein said one or more indicators of accuracy comprise an error value calculated based at least in part on a predicted loss from the predicted assessments for the one or more properties by an NHM and a loss from the reference event for the one or more properties.

16. The system of claim 15, wherein the error value comprises at least one of an absolute mean error, a median error, or a mean squared error.

17. The system of claim 13, wherein the computer system is programmed to:
determine an accuracy score for each of the NHMs based at least in part on said one or more indicators of accuracy for each of the NHMs; and
determine the ranking of the plurality of NHMs based at least in part on the accuracy scores.

18. The system of claim 17, wherein the computer system is programmed to determine the accuracy score by weighting at least some of said one or more indicators of accuracy.

19. The system of claim 13, wherein the computer system is programmed to determine the ranking of the plurality of NHMs based at least in part on costs to request the prediction of assessments from the plurality of NHMs.

20. The system of claim 13, wherein the computer system is programmed to determine the ranking of the plurality of NHMs in one or more categories for said one or more properties.
